(19) United States
(12) Patent Application Publication
(10) Pub. No.: US 2017/0080795 A1
(43) Pub. Date: Mar. 23, 2017

(54) UREA SUPPLYING APPARATUS

(71) Applicants: HYUNDAI MOTOR COMPANY, Seoul (KR); KIA MOTORS CORPORATION, Seoul (KR)

(72) Inventor: Jang Hyun JUNG, Suwon-si (KR)

(21) Appl. No.: 15/176,957

(22) Filed: Jun. 8, 2016

(30) Foreign Application Priority Data
Sep. 23, 2015 (KR) 10-2015-0134474

(51) Int. Cl. B60K 13/04

(52) U.S. Cl. CPC B60K 13/04; F01N 2610/02; F01N 2610/1413

(57) ABSTRACT

A urea supplying apparatus includes a filler neck including an opening, a supplying gun being removably inserted into the opening of the filler neck and injecting a urea, and an enclosing means being installed in an interior adjacent to the opening of the filler neck and elastically and tightly coupling at least a portion thereof to an outer surface of the supplying gun to thereby close a space between the outer surface of the supplying gun and an inner surface of the filler neck.

### CROSS-REFERENCE TO RELATED APPLICATION

This application claims the benefit of priority to Korean Patent Application No. 10-2015-0134474, filed on Sep. 23, 2015 with the Korean Intellectual Property Office, the disclosure of which is incorporated herein in its entirety by reference.

### TECHNICAL FIELD

The present disclosure relates to a urea supplying apparatus, and more particularly, to a urea supplying apparatus capable of preventing a urea from leaking out of an opening of a filler neck when the urea is injected into a urea tank.

### BACKGROUND

In a vehicle including a diesel engine, as a method for reducing nitrogen oxide (NOx), a selective catalytic reduction (SCR) catalyst is used and a urea is sprayed towards a front of the SCR catalyst, such that NOx contained in exhaust gas generated from the diesel engine is reduced.

Such urea may be injected through a supplying gun (injection nozzle), or the like into a urea tank mounted in the vehicle, and the urea tank may be connected to a filler neck into which the supplying gun is inserted. In addition, a retainer guiding the supplying gun or supporting a filler cap is installed in the filler neck.

Meanwhile, in order to facilitate an insertion and a separation of the supplying gun, a predetermined gap may be formed between an inner circumference surface of the retainer and an outer circumference surface of the supplying gun.

However, when the urea is injected into the urea tank through the supplying gun inserted into the filler neck, pressure in the urea tank is increased. As a result, the urea may flow through the gap between the retainer and the supplying gun in the filler neck and may leak out of an opening of the filler neck.

As described above, when the urea leaks out of the opening of the filler neck, a bad smell of urea may be propagated to the outside and urea stains may for around the opening of the filler neck. Therefore, if moisture is evaporated from the urea, a white powder is extracted and remains, which causes cosmetic appearance to be degraded.

### SUMMARY

The present disclosure has been made to solve the above-mentioned problems occurring in the prior art while advantages achieved by the prior art are maintained intact.

An aspect of the present disclosure provides a urea supplying apparatus capable of preventing a urea from leaking out of an opening of a filler neck by preventing an occurrence of a gap between a supplying gun and the filler neck, when the supplying gun is injected into the filler neck to inject the urea.

According to an exemplary embodiment of the present disclosure, a urea supplying apparatus may include a filler neck having an opening; a supplying gun being removably inserted into the opening of the filler neck to inject a urea; and an enclosing means is installed in an interior adjacent to the opening of the filler neck and to elastically and tightly couple at least a portion thereof to an outer surface of the supplying gun to thereby close a space between the outer surface of the supplying gun and an inner surface of the filler neck.

The enclosing means may include a bellows boot having a plurality of corrugations which are elastically deformable in a radial direction.

The bellows boot may be formed in a structure in which a diameter thereof is contracted along a supplying direction of the urea.

The bellows boot may have at least one contracted diameter part having an inner diameter smaller than an outer diameter of the supplying gun.

The bellows boot may have one or more reinforcement ribs formed on an outer surface thereof along an axial direction.

The bellows boot may have a plurality of reinforcement ribs, and the plurality of reinforcement ribs may be formed on the outer surface of the bellows boot to be spaced apart from each other in a circumferential direction.

The urea supplying apparatus may further include a retainer provided in the interior adjacent to the opening of the filler neck, wherein the retainer is formed of a contraction pipe of which a diameter is contracted in the supplying direction of the urea.

One end of the retainer may be directed to the opening of the filler neck, and the bellows boot may be removably coupled to the other end of the retainer.

The bellows boot may have a large diameter part attached onto the inner surface of the filler neck, and a small diameter part having a diameter smaller than the large diameter part.

One end of the bellows boot may be coupled to the retainer, a blocking part at the other end of the bellows boot may be extended in an outer diameter direction of the bellows boot, and an outer edge of the blocking part may contact with the inner surface of the filler neck.

One end of the bellows boot may be coupled to the retainer by a clamp band.

According to another exemplary embodiment of the present disclosure, a urea supplying apparatus may include a filler neck extended by a predetermined length, having one end connected to a urea tank, and having an opening formed at the other end thereof; a retainer formed of a metal material and installed in an interior adjacent to the opening of the filler neck; and a bellows boot has a plurality of corrugations and is coupled to the retainer, wherein the retainer has a large diameter part attached onto an inner surface of the filler neck, and a small diameter part having a diameter smaller than the large diameter part, and the bellows boot is removably coupled to the small diameter part of the retainer.

A fitting part having an inner diameter greater than the small diameter part of the retainer may be formed at one end of the bellow boot, and the fitting part of the bellows boot may be coupled to an end portion of the small diameter part of the retainer by a clamp band clamped to an outer circumference surface of the fitting part in a state in which the fitting part of the bellows boot is fitted into the end portion of the small diameter part of the retainer.

A taper part formed to be inclined toward an outer diameter direction may be formed at the end portion of the small diameter part of the retainer, and the taper part may be fit into an inner surface of the corrugation adjacent to the fitting part of the bellows boot.

### BRIEF DESCRIPTION OF THE DRAWINGS

The above and other objects, features and advantages of the present disclosure will be more apparent from the following detailed description taken in conjunction with the accompanying drawings.

FIG. 1 is a perspective view illustrating a state in which a filler neck of a urea supplying apparatus according to an exemplary embodiment of the present disclosure is installed in a urea tank.

FIG. 2 is a view of a urea supplying apparatus according to an exemplary embodiment of the present disclosure.

FIG. 3 is a cross-sectional view illustrating a state in which a supplying gun is inserted into an opening of a filler neck of a urea supplying apparatus according to an exemplary embodiment of the present disclosure.

### DETAILED DESCRIPTION

Hereinafter, exemplary embodiments of the present disclosure will be described in detail with reference to the accompanying drawings. For reference, sizes of components, thicknesses of lines, and the like which are shown in the drawings referenced for describing the present disclosure may be slightly exaggerated for convenience of understand. Further, since the terminologies used to describe the present disclosure are defined in consideration of the functions in the present disclosure, they may be construed in different ways depending on a user, an intention of an operator, practices, and the like. Therefore, the definition of the terminologies should be construed based on the contents throughout the specification.

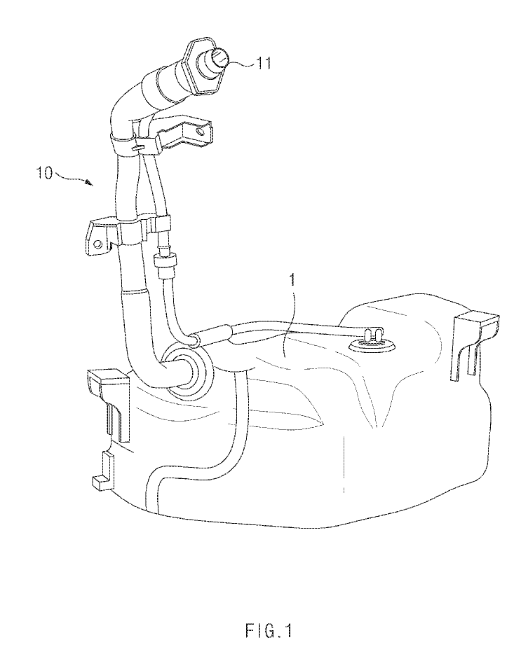

FIGS. 1 to 3 are views illustrating a urea supplying apparatus according to exemplary embodiments of the present disclosure.

The present disclosure relates to a urea supplying apparatus for injecting a urea into a urea tank 1 by a supplying gun 5.

Referring to FIGS. 1 to 3, the urea supplying apparatus according to the present disclosure may include a filler neck 10 extended from a urea tank 1 by a predetermined length, a supplying gun 5 may be removably inserted into the filler neck 10, and an enclosing means may close a space between an inner surface of the filler neck 10 and an outer surface of the supplying gun 5.

Referring to FIG. 1, the filler neck 10 may be extended by the predetermined length, one end of the filler neck 10 may be communicatively connected to one side of the urea tank 1, and the other end of the filler neck 10 may have an opening 11 into which the supplying gun 5 is removably inserted.

Since the filler neck 10 may be formed in a structure into which it is extended by the predetermined length and is connected to the urea tank 1, a supplying path of a urea toward the urea tank 1 may be effectively implemented in a narrow space in a vehicle.

After the supplying gun 5 is inserted into the opening 11 of the filler neck 10, a predetermined amount of urea may be injected into the urea tank 1 through the filler neck 10 by driving an injection pump (not illustrated), and after the supplying of the urea is completed, the supplying gun 5 may be separated from the opening 11 of the filler neck 10. Thereafter, the opening 11 of the filler neck 10 may be closed by a closing cap (not illustrated).

A retainer 20 guiding the insertion of the supplying gun 5 or supporting the closing cap (not illustrated) may be installed in the filler neck 10, and may be made of a metal material.

The retainer 20 may be formed of a contraction pipe of which a diameter is contracted in a supplying direction of the urea by the supplying gun 5.

According to an exemplary embodiment, the retainer 20 may have a large diameter part 21 attached to the inner surface of the filler neck 10, a small diameter part 22 having a diameter smaller than the large diameter part 21, and a connecting part 23 connecting the large diameter part 21 and the small diameter part 22 to each other.

Particularly, an outer surface of the large diameter part 21 of the retainer 20 may also be fixedly attached onto the inner surface of the filler neck 10 by a welding, or the like.

One end of the retainer 20, that is, an end portion of the large diameter part 21 may be spaced apart from the opening 11 of the filler neck 10, and the other end of the retainer 20, that is, an end portion of the small diameter part 22 may be disposed to be directed to the urea tank 1.

The enclosing means may include a bellows boot 30 installed in an interior adjacent to the opening 11 of the filler neck 10, and the bellows boot 30 may be formed of an elastic material such as rubber, or the like and may be formed of a material which is easy to elastically deform in a radial direction.

One end of the bellows boot 30 may be removably coupled to the other end of the retainer 20, that is, an end portion of the small diameter part 22, and another end of the bellows boot 30 may be disposed to be directed to the urea tank 1.

The bellows boot 30 may have a plurality of corrugations 31a, 31b, and 31c formed on an outer surface thereof, and since the plurality of corrugations 31a, 31b, and 31c are formed of an elastic material such as rubber, or the like, it may be easy to elastically deform the plurality of corrugations 31a, 31b, and 31c in a radial direction. Particularly, an inner surface of at least one corrugation 31c among the plurality of corrugations 31a, 31b, and 31c may be elastically and tightly coupled to the outer surface of the supplying gun 5. Thereby, the space between the inner surface of the supplying gun 5 and the inner surface of the filler neck 10 may be closed.

According to various exemplary embodiments, the plurality of corrugations 31a, 31b, and 31c may be formed in a structure in which a diameter thereof is gradually contracted along a supplying direction of the urea.

According to another exemplary embodiment, the corrugation 31c positioned at the lowest portion of the bellows boot 30 may be formed of a contracted diameter part 31c having an inner diameter smaller than an outer diameter of the supplying gun 5.

For example, since the bellows boot 30 according to the various exemplary embodiments of the present disclosure may have one or more contracted diameter parts 31c having the inner diameter smaller than the outer diameter of the supplying gun 5, when the supplying gun 5 is inserted into the bellows boot 30, the contracted diameter part 31c may be tightly coupled to the bellows boot 30 while being extended in an outer diameter direction. Thereby, a space between the outer surface of the supplying gun 5 and the inner surface of the bellows boot 30 may be reliably closed.

The bellows boot 30 may have one or more reinforcement ribs 33 formed on an outer surface thereof along an axis direction, or along a bore axis, and stiffness of the bellows boot 30 in the axis direction may be reinforced by the reinforcement ribs 33. Thus, when the supplying gun 5 is injected into or separated from the bellows boot 30, it may be effectively prevented that the bellows boot 30 is deformed along the axis direction (reversed in the axis direction, etc.).

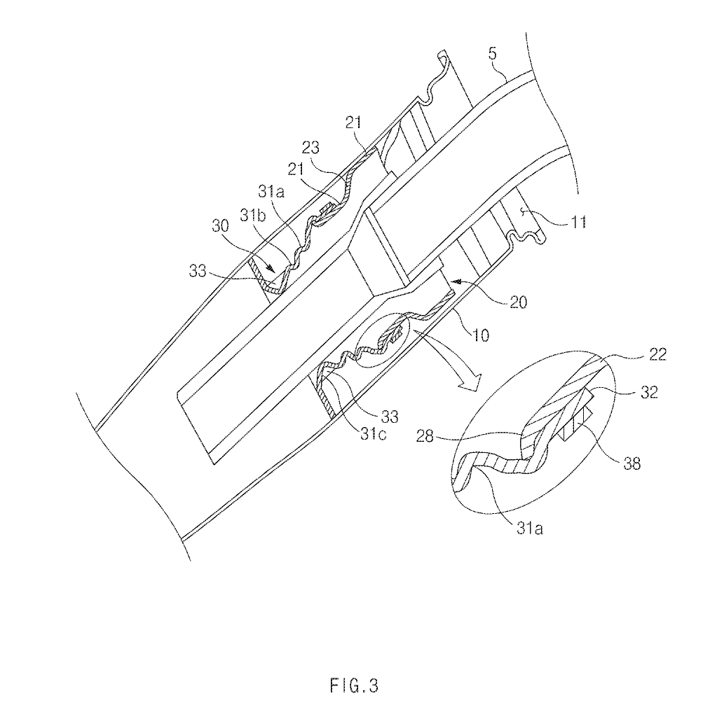

According to various exemplary embodiments, the bellows boot 30 may have a plurality of reinforcement ribs 33, and the plurality of reinforcement ribs 33 may be formed on the outer surface of the bellows boot 30 to be spaced apart from each other in a circumferential direction as illustrated in FIG. 3.

Particularly, the reinforcement ribs 33 may be formed on an outer surface of the contracted diameter part 31c, thereby making it possible to more effectively prevent the contracted diameter part 31c from being deformed in the axis direction.

One end of the bellows boot 30 may have a fitting part 32 fitted into the other end of the retainer 20, that is, an end portion of the small diameter part 22, and since the fitting part 32 has an outer diameter greater than the small diameter part 22, the fitting part 32 may be fit into the outer surface of the small diameter part 22. As a clamp band 38 may be clamped in a state in which the fitting part 32 of the bellows boot 30 is fit into the other end of the retainer 20, that is, the small diameter part 22, the bellows boot 30 may be very firmly coupled to the retainer 20.

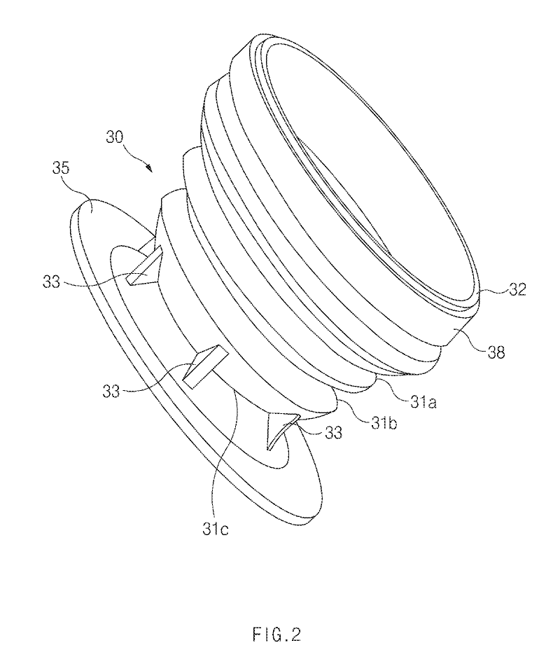

At the other end of the bellows boot 30, a blocking part 35 may be extended to an outer diameter direction of the bellows boot 30, and an outer edge of the blocking part 35 may contact with the inner surface of the filler neck 10 as illustrated in FIG. 2. Accordingly, as illustrated in FIG. 2, since the space between the inner surface of the filler neck 10 and the outer surface of the supplying gun 5 may be blocked by the blocking part 35, it may be effectively prevented that the urea leaks out of the opening 11 of the filler neck 10 when the urea is injected.

Meanwhile, the retainer 20 may have a taper part 28 formed to be inclined toward an outer diameter direction at an end portion of the small diameter part 22, and when the fitting part 32 of the bellows boot 30 is fit into the outer surface of the small diameter part 22, the taper part 28 of the retainer 20 may be fitted into the inner surface of the corrugation 31a adjacent to the fitting part 32 of the bellows boot 30. Thereby, the retainer 20 and the fitting part 32 of the bellows boot 30 may be airtightly coupled to each other to be sealed.

Particularly, the taper part 28 may be formed to be inclined at an angle corresponding to the corrugation 31a of the bellows boot 30, such that the bellows boot 30 may be more airtightly coupled to the retainer 20 to be sealed.

As described above, according to the exemplary embodiments of the present disclosure, the urea supplying apparatus may prevent the urea from leaking out of the opening of the filler neck by preventing the occurrence of the gap between the supplying gun and the filler neck when the supplying gun is injected into the filler neck to inject the urea.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A urea supplying apparatus comprising:
a filler neck including an opening;
a supplying gun being removably inserted into the opening of the filler neck and injecting a urea; and
an enclosing means being installed in an interior adjacent to the opening of the filler neck and elastically and tightly coupling at least a portion thereof to an outer surface of the supplying gun to thereby close a space between the outer surface of the supplying gun and an inner surface of the filler neck.

2. The urea supplying apparatus according to claim 1, wherein the enclosing means includes a bellows boot having a plurality of corrugations which are elastically deformable in a radial direction.

3. The urea supplying apparatus according to claim 2, wherein the bellows boot is formed in a structure in which a diameter thereof is contracted along a supplying direction of the urea.

4. The urea supplying apparatus according to claim 3, wherein the bellows boot has at least one contracted diameter part having an inner diameter smaller than an outer diameter of the supplying gun.

5. The urea supplying apparatus according to claim 4, wherein the bellows boot has one or more reinforcement ribs formed on an outer surface thereof along an axial direction.

6. The urea supplying apparatus according to claim 5, wherein the bellows boot has a plurality of reinforcement ribs,
wherein the plurality of reinforcement ribs are formed on the outer surface of the bellows boot to be spaced apart from each other in a circumferential direction.

7. The urea supplying apparatus according to claim 6, further comprising a retainer provided in the interior adjacent to the opening of the filler neck,
wherein the retainer is formed of a contraction pipe of which a diameter is contracted in the supplying direction of the urea.

8. The urea supplying apparatus according to claim 7, wherein one end of the retainer is directed to the opening of the filler neck, and
the bellows boot is removably coupled to another end of the retainer.

9. The urea supplying apparatus according to claim 8, wherein the bellows boot has a large diameter part attached onto the inner surface of the filler neck, and a small diameter part having a diameter smaller than the large diameter part.

10. The urea supplying apparatus according to claim 9, wherein one end of the bellows boot is coupled to the retainer,
a blocking part at the other end of the bellows boot is extended in an outer diameter direction of the bellows boot, and
an outer edge of the blocking part contacts with the inner surface of the filler neck.

11. The urea supplying apparatus according to claim 10, wherein one end of the bellows boot is coupled to the retainer by a clamp band.

12. A urea supplying apparatus comprising:
a filler neck being extended by a predetermined length, having one end connected to a urea tank, and having an opening formed at another end thereof;
a retainer being formed of a metal material and installed in an interior adjacent to the opening of the filler neck; and
a bellows boot having a plurality of corrugations and being coupled to the retainer,
wherein the retainer has a large diameter part attached onto an inner surface of the filler neck, and a small diameter part having a diameter smaller than the large diameter part, and
the bellows boot is removably coupled to the small diameter part of the retainer.

13. The urea supplying apparatus according to claim 12, wherein a fitting part having an inner diameter greater than the small diameter part of the retainer is formed at one end of the bellow boot, and
the fitting part of the bellows boot is coupled to an end portion of the small diameter part of the retainer by a clamp band clamped to an outer circumference surface of the fitting part in a state in which the fitting part of the bellows boot is fitted into the end portion of the small diameter part of the retainer.

14. The urea supplying apparatus according to claim 13, wherein a taper part formed to be inclined toward an outer diameter direction is formed at the end portion of the small diameter part of the retainer, and
the taper part is fitted into an inner surface of the corrugation adjacent to the fitting part of the bellows boot.
